(19) United States
(12) Patent Application Publication
(10) Pub. No.: US 2024/0181392 A1
(43) Pub. Date: Jun. 6, 2024

(54) IMPROVED REVERSE OSMOSIS OR NANOFILTRATION PROCESS FOR CLEANING WATER

(71) Applicant: IDE WATER TECHNOLOGIES LTD., KADIMA (IL)

(72) Inventors: Alex DRAK, Kadima (IL); Tomer EFRAT, Kadima (IL); Roi ZAKEN, Kadima (IL)

(21) Appl. No.: 18/408,500

(22) Filed: Jan. 9, 2024

Related U.S. Application Data
(63) Continuation-in-part of application No. 18/477,542, filed on Sep. 28, 2023.
Application No. 18/477,542 is a continuation-in-part of application No. 17/347,643, filed on Jun. 15, 2021, now Pat. No. 11,890,577.
Application No. 17/347,643 is a continuation of application No. 15/777,207, filed on May 17, 2018, now Pat. No. 11,071,949.

(30) Foreign Application Priority Data
Jul. 23, 2015 (GB) 1512979.4

(51) Int. Cl. B01D 61/08; B01D 61/02; B01D 61/04; B01D 61/12; C02F 1/00; C02F 1/28; C02F 1/42; C02F 1/44; C02F 9/00

(52) U.S. Cl. CPC B01D 61/08; B01D 61/02; B01D 61/025; B01D 61/027; B01D 61/04; B01D 61/12; C02F 1/28; C02F 1/42; C02F 1/441; C02F 1/442; C02F 9/00; B01D 2311/04; B01D 2311/08; B01D 2311/25; B01D 2311/2523; B01D 2311/2623; B01D 2311/2626; B01D 2311/2649; B01D 2311/268; B01D 2313/10; C02F 1/004; C02F 1/008; C02F 2209/03; C02F 2209/05; C02F 2209/40; C02F 2301/046; C02F 2303/24

(57) ABSTRACT

Disclosed herein is a system for cleaning feed water of variable quality, the system including an inlet for selectively delivering feed water to one or other of at least two feed chambers, each feed chamber having a delivery pipe for delivering feed water to a reverse osmosis or nanofiltration, a pump to deliver the feed water from one of the chambers through its associated delivery pipe to the reverse osmosis or nanofiltration to create a concentrated feed stream and a product water stream, return pipes for selectively returning the concentrated feed stream to one or another of the at least two feed chambers, a product water outlet for removal of the product water, and switching mechanisms and/or switchers for switching the delivery of the concentrated feed stream between the selectable return pipes upon detection of a predetermined reduction in efficiency within one or another of the feed chambers.

### CROSS-REFERENCE TO RELATED APPLICATIONS

This application is a continuation-in-part of U.S. application Ser. No. 18/477,542, which is a continuation-in-part of U.S. application Ser. No. 17/347,643, filed on Jun. 15, 2021, which is a continuation of U.S. application Ser. No. 15/777,207, filed on May 17, 2018, now U.S. Pat. No. 11,071,949, which is a § 371 of PCT/IB2016/054172, filed Jul. 13, 2016, which claims the benefit of GB patent application 1512979.4, filed Jul. 23, 2015, each of which is hereby incorporated by reference in its respective entirety as if fully set forth herein.

### FIELD

This disclosure relates to an improved method and system for the cleaning or desalination of feed water by reverse osmosis (RO) or nanofiltration (NF) in an open circuit.

### BACKGROUND

Desalination by reverse osmosis (RO) occurs when salt water solution is compressed against semi-permeable membranes at a pressure higher than its osmotic pressure. An example of this process is the “Plug-Flow Desalination” method which involves passing of pressurized feed flow through pressure vessels having semi-permeable membranes. The feed then separates into a non-pressurized flow of desalted permeate and a pressurized flow of brine effluent. Generally, the brine effluent is a waste product.

Nanofiltration (NF) is also a semi-permeable membrane filtration-based method that uses nanometer sized cylindrical through-pores. Nanofiltration can be used to treat all kinds of water including ground, surface, and wastewater. Nanofiltration membranes have the ability to remove a significant fraction of dissolved salts.

The recovery rate achieved in the aforementioned processes depends upon the quality of the feed water and applied pressure. Generally, feed water is fed to the system for providing a waste brine stream and a product water stream.

Given the foregoing, there exists a significant need for devices, systems, and methods for cleaning and/or desalinating feed water.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In certain embodiments, the disclosed embodiments may include one or more of the features described herein.

In general, it is an aim of the present disclosure is to provide an improved method for the cleaning or desalination of feed water by reverse osmosis or nanofiltration in an open circuit that can process feed water of different qualities and deal with different recovery rates.

It is a further aim of the present disclosure to provide an improved system for the cleaning or desalination of feed water by reverse osmosis or nanofiltration in an open circuit that can process feed water of different qualities and deal with different recovery rates.

Accordingly, at least one embodiment of the present invention provides a method of cleaning feed water (FW) of variable quality, the method comprising: delivering feed water (FW) to one of at least two feed chambers, pumping feed water from one of the feed chambers through a reverse osmosis (RO) or nanofiltration (NF) membrane to create a concentrated feed stream and a product water stream (PW), reducing the pressure of the concentrated feed stream, returning the concentrated feed stream to the original feed chamber for delivery back through the reverse osmosis or nanofiltration, switching the return delivery of the concentrated feed stream to the at least one other feed chamber upon detecting a predetermined reduction in the efficiency of the RO or NF process within the original feed chamber, removing the concentrated feed (CW) from the original feed chamber and delivering fresh feed water to this chamber during continuous circulation of the feed water from the at least one other feed chamber through the reverse osmosis or nanofiltration back to the at least one other feed chamber, and passing the feed stream through a desaturation unit prior to, or after, its passage through the reverse osmosis or nanofiltration.

Preferably, the method comprises switching delivery of the concentrated feed stream from the at least one other feed chamber to the original feed chamber upon detecting a predetermined reduction in the efficiency of the RO or NF process within the at least one other feed chamber, removing the concentrated feed (CW) from the at least one other feed chamber and delivering fresh feed water (FW) to this chamber.

This enables cleaning of the feed chamber to take place during removal of the concentrated feed stream therefrom, while feed water continues to be fed to the reverse osmosis or nanofiltration chamber from the other feed chamber.

Any appropriate desaturation unit may be used to remove contaminants, such as dissolved salts and sparingly soluble salts from the feed stream prior to, or after, its passage through the reverse osmosis or nanofiltration. Examples include fluidized bed reactors, softeners, ion exchangers and/or an absorber.

The reduction in efficiency of the RO or NF process may be detected in a variety of ways. Preferably, detection of a predetermined maximum salt concentration in the chamber causes switching of the return delivery to the at least one other feed chamber. More preferably, the predetermined maximum salt concentration corresponds to the maximum osmotic pressure at which the reverse osmosis or nanofiltration can operate.

Preferably, the step of reducing the pressure of the concentrated feed stream prior to its return delivery to one or other of the feed chambers reduces the pressure of the concentrated feed stream is reduced to substantially atmospheric pressure. This may be achieved by an open loop wherein the feed stream is passed back to a chamber that is open to atmosphere. Alternatively or additionally, a pressure exchanger may be used to reduce the pressure of the concentrated feed stream. Passing the feed stream through a desaturation unit may occur prior to, or after, this pressure reduction.

The method may also include pre-treating the feed water prior to its delivery to the reverse osmosis or nanofiltration. For example, the pre-treatment may comprise filtering the feed water prior to its delivery to the reverse osmosis or nanofiltration. Furthermore, the filtered feed water may be pumped at high pressure through the membrane.

According to at least another embodiment of the present invention, there is provided a system for cleaning feed water of variable quality, the system comprising: an inlet for selectively delivering feed water (FW) to one or other of at least two feed chambers, each feed chamber having a delivery pipe for delivering feed water to a reverse osmosis or nanofiltration, a pump to deliver the feed water from one of the chambers through its associated delivery pipe to the reverse osmosis (RO) or nanofiltration (NF) membrane to create a concentrated feed stream and a product water stream (PW), return pipes for selectively returning the concentrated feed stream to one or other of the at least two feed chambers, a product water outlet for removal of the product water (PW), switching mechanisms and/or switchers for switching the delivery of the concentrated feed stream between the selectable return pipes upon detection of a predetermined reduction in efficiency of the RO or NF process, such as detection of a maximum salt concentration, within one or other of the feed chambers, and a desaturation unit provided in at least one feed stream between the feed chamber and the reverse osmosis or nanofiltration or in at least one return pipe between the reverse osmosis or nanofiltration and the feed chamber.

The switching mechanisms and/or switchers are preferably adapted to enable the delivery of feed water from a first chamber through a first delivery pipe to the reverse osmosis membrane to be recycled through its return pipe to the first chamber until the predetermined reduction in efficiency is detected in that chamber whereupon the switching mechanisms and/or switchers enable feed water to be delivered from a second chamber though a second delivery pipe to the reverse osmosis or nanofiltration to be recycled through its return pipe to the second chamber until a predetermined reduction in efficiency is detected in the second chamber.

Preferably, the switching mechanisms and/or switchers also activate removal of concentrated feed water from the feed chamber upon detection of the predetermined reduction in efficiency, such as upon detection of a maximum salt concentration within that chamber, and the delivery of fresh feed water to the reverse osmosis or nanofiltration from the other feed chamber.

Additionally, the switching mechanisms and/or switchers may activate the delivery of fresh feed water to the chamber following the removal of the concentrated feed stream from that chamber.

The desaturation unit is provided in either the feed streams between the feed chamber and the reverse osmosis or nanofiltration, or in the return pipes between the reverse osmosis or nanofiltration brine and the feed chamber. Any suitable type of desaturation unit may be provided.

Preferably, the system according to at least one embodiment of the present invention is an open loop system wherein the pressure of the concentrated feed stream in the return pipes is reduced by passing the feed stream to chambers that are open to atmosphere. Additionally or alternatively, a pressure exchanger may be provided within the system. Preferably, the pressure of the concentrated feed stream in the return pipes is reduced to substantially atmospheric pressure. The desaturation unit may be provided between the pressure exchanger and the feed chamber.

The system may include a pre-treatment unit, such as a filter unit, for pre-treating the feed water prior to its delivery to the reverse osmosis or nanofiltration.

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a schematic diagram of a water cleaning system, according to at least one embodiment of the present invention.

FIG. 2 is a schematic diagram of a water cleaning system, according to at least one embodiment of the present invention.

FIG. 3 is a flow diagram illustrating the steps of the method according to at least one preferred embodiment of the present invention.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, “at least one of A, B, and C” indicates A or B or C or any combination thereof. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

As used herein, ranges are used herein in shorthand, so as to avoid having to list and describe each and every value within the range. Any appropriate value within the range can be selected, where appropriate, as the upper value, lower value, or the terminus of the range.

“About” means a referenced numeric indication plus or minus 10% of that referenced numeric indication. For example, the term “about 4” would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims, each numerical parameter should be construed in light of the number of significant digits and ordinary rounding approaches.

The words “comprise,” “comprises,” and “comprising” are to be interpreted inclusively rather than exclusively. Likewise, the terms “include,” “including,” and “or” should all be construed to be inclusive, unless such a construction is clearly prohibited from the context. The terms “comprising” or “including” are intended to include embodiments encompassed by the terms “consisting essentially of” and “consisting of.” Similarly, the term “consisting essentially of” is intended to include embodiments encompassed by the term “consisting of.” Although having distinct meanings, the terms “comprising,” “having,” “containing,” and “consisting of” may be replaced with one another throughout the description of the invention.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Wherever the phrase “for example,” “such as,” “including” and the like are used herein, the phrase “and without limitation” is understood to follow unless explicitly stated otherwise.

“Typically” or “optionally” means that the subsequently described event or circumstance may or may not occur, and that the description includes instances where said event or circumstance occurs and instances where it does not.

Generally, the present disclosure is directed to devices, systems, and methods for cleaning and/or desalinating water. In particular, embodiments of the invention provide an improved reverse osmosis and/or nanofiltration method and system for enabling variable quality feed water to be used with different recovery rates.

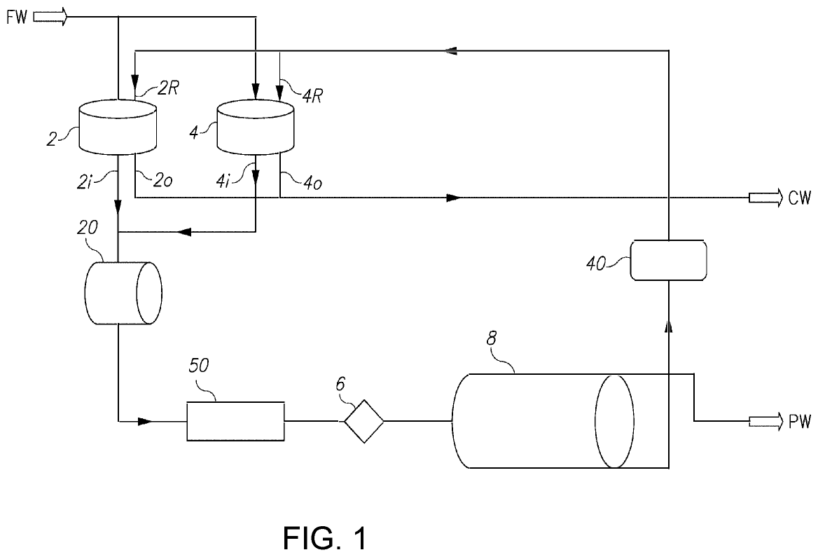

Referring to FIG. 1 of the accompanying drawings, one embodiment of a system for cleaning feed water of variable quality is illustrated. The embodiment illustrates a reverse osmosis process and system, but a nanofiltration membrane may be used as an alternative to the reverse osmosis membrane. Feed water or salt water (FW) is introduced into a first feed chamber 2 from which it is directed through a delivery pipe 2i to a desaturation unit 20 (for example, in the form of a softener, ion exchanger or an absorber) followed by a pre-treatment unit 50, such as a filter unit.

A high pressure pump 6 then pressurizes the pre-treated feed water prior to its passage through a reverse osmosis membrane 8 from which product water PW is produced, together with a concentrated brine stream CW. Normally, the brine stream would then be discarded.

In at least one embodiment of the present invention, the concentrated brine stream CW is delivered back to the first feed chamber via a pressure exchanger 40 in which its pressure is reduced back to substantially atmospheric pressure. The system is also an open loop wherein the chambers are open to atmosphere. The concentrated brine stream is mixed with additional feed water in the first chamber and then recycled back through the system to provide more product water PW and concentrated brine CW for recycling back to the chamber 2.

The system is provided with monitoring mechanisms and/or monitors for monitoring the efficiency of the reverse osmosis process. In this respect, it is to be appreciated that repeated recycling of the brine stream will reduce the efficiency of the process over time as the concentration of the feed water increases. To address this issue, the system is provided with a second feed chamber 4. When the concentration of the feed water in the first chamber 2 reaches a predetermined level, the delivery pipe 2i is shut and feed water is introduced into the system from a second chamber 4 via delivery pipe 4i. This feed water is then passed through the desaturation unit 20 and pre-treatment unit 50, pumped through the reverse osmosis membrane 8 to provide concentrated brine and product water PW. The concentrated brine is recycled back to the second chamber 4 via the pressure exchanger 40 and a return pipe 4R for recycling through the system with further feed water.

While feed water is being introduced from the second chamber, the highly concentrated brine water CW in the first chamber is removed via outlet pipe 20. The chamber is cleaned and fresh feed water is introduced into the chamber 2.

The system continues to monitor the efficiency of the reverse osmosis process. Over time, the feed water from the second chamber reaches a predetermined concentration, preferably being around the maximum osmotic pressure at which the reverse osmosis membrane can operate, at which point the inlet 4i of the second chamber is closed and feed water is again delivered through the system from the first chamber 2 back to the first chamber via the pressure exchanger 40 and return pipe 2R. The concentrated brine in the second chamber is removed via outlet 40 and fresh water is delivered into the second chamber 4.

In this manner, the system is able to cope with feed water of different quality and work with different recovery rates.

It is to be appreciated that more than two feed chambers may be provided working consecutively to allow recycling and cleaning of the feed water. Multiple chambers working in consecutive groups may also be provided in the system.

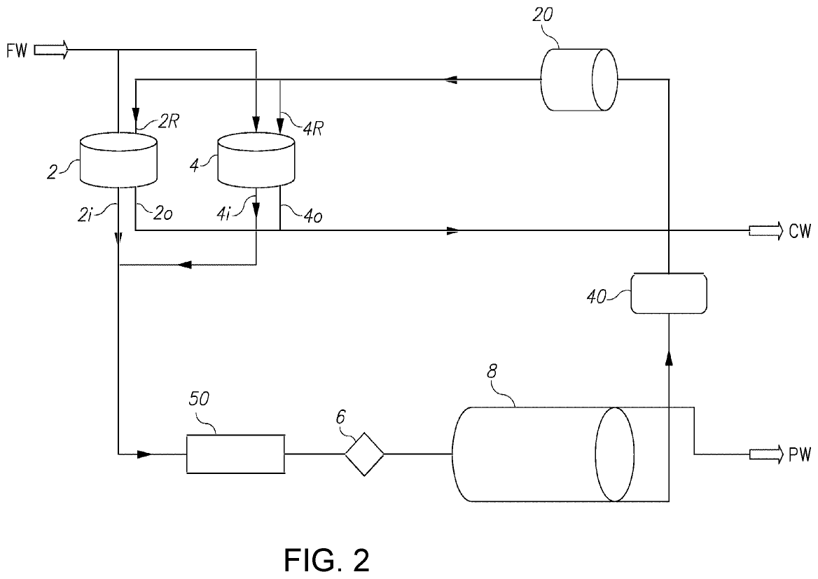

The desaturation unit (20) may only come into play when the recycled feed water reaches a predetermined salt concentration. Alternatively, the unit may be operational at all times. The unit may be provided elsewhere in the system, for example after the pressure exchanger 40 in the return line, as shown in FIG. 2 of the accompanying drawings.

The system is preferably provided with appropriate electronic control mechanisms and/or controllers for automatically switching between delivery of feed water from the respective chambers upon detection of predetermined reduction in the efficiency of the overall process, for example, corresponding to a particular concentration being detected within each feed chamber.

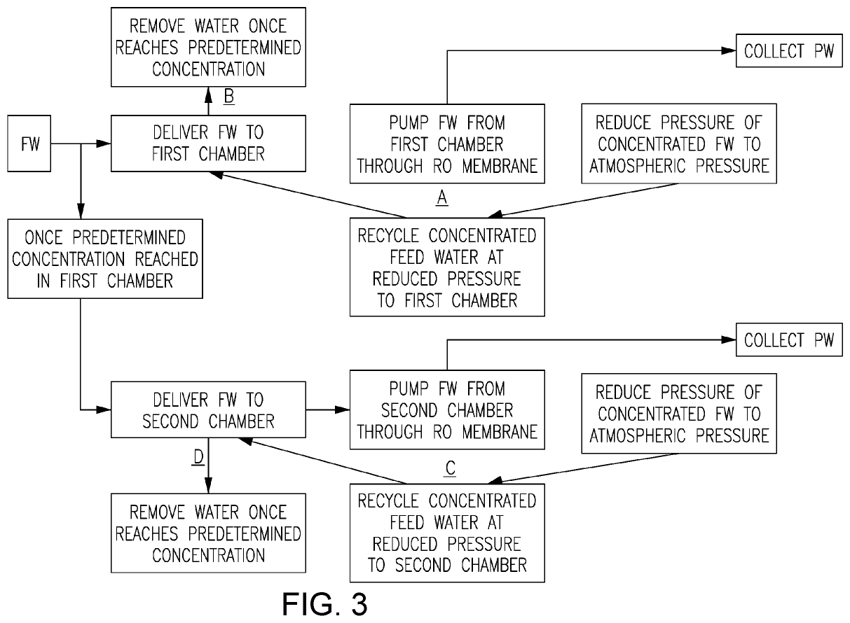

FIG. 3 of the accompanying drawings illustrates the basic steps of a method according to at least one embodiment of the present invention, again described in relation to a reverse osmosis process but embodiments of the invention are also applicable to nanofiltration. Initially feed water is delivered to a first chamber from which it is pumped through a RO membrane to provide a clean product water PW and a concentrated feed water. The pressure of the concentrated feed water exiting the RO membrane is reduced to atmospheric pressure to that is can be recycled back to the open first chamber for forming part of feed water (see “A” in FIG. 3). This cycle is repeated until the concentration of the feed water in this chamber reaches a predetermined level, at which point the water is removed, the chamber cleaned and fresh water is introduced into the first chamber (see “B”).

During removal of the water of the first chamber, feed water is introduced into the system from a second chamber. Again the feed water is pumped through the RO membrane and then recycled back to the second chamber via a pressure exchanger for forming part of the feed water (see “C” in FIG. 3). This cycle is repeated until the concentration of the feed water in this second chamber reaches a predetermined level. The water is then removed, the chamber cleaned and fresh water is introduced into the second chamber (see “D”). During removal of the water, feed water is again introduced from the first chamber and recycled as illustrated by steps A in FIG. 3 until the concentration reaches a predetermined level, at which point feed water is introduced from the second chamber and recycled as illustrated in steps C.

Ideally, the method further includes an additional step of removing the salts from the feed water, either before or after its passage through the RO membrane. This may be achieved using any suitable desaturation unit, such as one containing a softener, ion exchanger or an absorber.

It should be appreciated that any of the embodiments of the invention described herein may utilize one or more membranes for filtering and/or cleaning water. Such membranes may, but need not, be RO and/or NF membranes. Non-limiting examples of membranes that can be used with any one or more of the embodiments described herein include RO membranes, NF membranes, forward osmosis (FO) membranes, ultrafiltration (UF) membranes, low rejection membranes, osmotically assisted reverse osmosis (OARO) and any combination thereof.

It should further be appreciated that any of the embodiments of the invention described herein may utilize one, or more than one, of at least the following aspects: at least one feed chamber, at least one membrane (including, for instance, membranes of different types), at least one desaturation unit, at least one switching mechanism, at least one pump (e.g., to deliver feed water from a given feed chamber to the at least one membrane), at least one return pipe (e.g., for returning the concentrated feed stream to one or more given feed chambers), at least one product water outlet, and/or at least one pressure exchanger.

In at least another embodiment of the invention, a method of cleaning feed water of variable quality is disclosed. The method comprises delivering feed water to at least one feed chamber (e.g., a first feed chamber), pumping the feed water from the at least one feed chamber through a membrane to create a concentrated feed stream and a product water stream, reducing the pressure of the concentrated feed stream (e.g., via a pressure exchanger), returning the concentrated feed stream to the at least one feed chamber for delivery back through the membrane, the concentrated feed stream combining with additional feed water in the at least one feed chamber, removing the concentrated feed stream from the at least one feed chamber and delivering fresh feed water to the at least one feed chamber during circulation of the feed water from the membrane back to the at least one feed chamber; and passing the feed water through at least one desaturation unit.

The at least one desaturation unit may be positioned in one or more specific locations selected from the group consisting of: prior to passage of the feed water through the membrane, after passage of the feed water through the membrane, before delivering the feed water to the at least one feed chamber, and combinations thereof.

The method may further comprise switching the return delivery of the concentrated feed stream to at least one other feed chamber (e.g., a second feed chamber) upon detecting a predetermined reduction in filtration efficiency within the at least one feed chamber. Such predetermined reduction in filtration efficiency may comprise, for instance, a predetermined reduction in efficiency of the aforementioned membrane.

The method may further comprise switching delivery of the concentrated feed stream from the at least one other feed chamber to the at least one feed chamber upon detecting a predetermined reduction in filtration efficiency within the at least one other feed chamber. This predetermined reduction in filtration efficiency may comprise, for instance, a predetermined reduction in efficiency of the aforementioned membrane.

The method may further comprise removing the concentrated feed from the at least one other feed chamber.

The method may further comprise delivering fresh feed water to the at least one other feed chamber.

The method may further comprise cleaning the at least one feed chamber during removal of the concentrated feed stream therefrom.

In at least one embodiment, the predetermined reduction in filtration efficiency is detected by a predetermined maximum salt concentration corresponding to the maximum osmotic pressure at which the membrane can operate.

In at least another embodiment, the pressure of the concentrated feed stream is reduced to substantially atmospheric pressure

The method may further comprise pre-treating the feed water prior to delivery of the feed water to the membrane. Such pre-treatment may comprise filtering the feed water prior to delivery of the feed water to the membrane.

The method may further comprise pumping filtered feed water (e.g., from pre-treatment) at high pressure through the membrane.

In at least one embodiment, the reducing the pressure of the concentrated feed stream is performed prior to the returning the concentrated feed stream to the at least one feed chamber.

In at least another embodiment, the detecting the first predetermined reduction in filtration efficiency further comprises detecting a predetermined maximum salt concentration within the at least one feed chamber.

In at least another embodiment, one or more feed chambers (e.g., the at least one feed chamber, the at least one other feed chambers) is open to atmosphere.

As mentioned above herein, the membrane may be selected from the group consisting of: a reverse osmosis (RO) membrane, a nanofiltration (NF) membrane, a forward osmosis (FO) membrane, an ultrafiltration (UF) membrane, low rejection membranes and combinations thereof.

In at least one embodiment of the invention, a system for cleaning feed water of variable quality is described. The system comprises an inlet for selectively delivering feed water to at least one feed chamber (e.g., a first feed chamber), the at least one feed chamber having a delivery pipe for delivering the feed water to a membrane, at least one pump to deliver the feed water from the at least one feed chamber, through the delivery pipe, to the membrane, to create a concentrated feed stream and a product water stream, at least one return pipe for selectively returning the concentrated feed stream to the at least one feed chamber, at least one product water outlet for removal of the product water stream, at least one desaturation unit positioned in a location selected from the group consisting of: prior to passage of the feed water through the membrane, after passage of the feed water through the membrane, before delivering feed water to the at least one feed chamber, and combinations thereof, and at least one pressure exchanger that is configured to reduce pressure of the concentrated feed stream prior to feeding the concentrated feed stream through the at least one desaturation unit.

The system may further comprise switching mechanisms and/or switchers for switching delivery of the concentrated feed stream between the at least one return pipe and at least another return pipe that leads to, and/or is connected to, at least one other feed chamber (e.g., a second feed chamber). Such switching can be activated upon detection of a predetermined reduction in filtration efficiency in the at least one feed chamber and/or in the membrane.

In at least one embodiment, the switching mechanisms are configured to enable delivery of the feed water from the at least one feed chamber through the delivery pipe to the membrane, to be recycled through the at least one return pipe to the at least one feed chamber until the predetermined reduction in filtration efficiency in the at least one feed chamber is detected. Upon such detection, the switching mechanism can enable the feed water to be delivered from the at least one other feed chamber through a second delivery pipe to the membrane, to be recycled through the at least another return pipe to the at least one other feed chamber until the predetermined reduction in filtration efficiency is detected in the at least one other feed chamber.

In at least another embodiment, the switching mechanisms are configured to enable (i) removal of the concentrated feed stream from the at least one feed chamber upon detection of the predetermined reduction in filtration efficiency in the at least one feed chamber, and/or (ii) delivery of fresh feed water to the membrane.

In at least another embodiment, the switching mechanisms are configured to deliver the fresh feed water to the at least one feed chamber following the removal of the concentrated feed stream from the at least one feed chamber.

In at least another embodiment, the at least one desaturation unit can be provided in one or more locations, including, for instance, in a stream (e.g., a feed stream) between one or more feed chambers (e.g., the at least one feed chamber, the at least one other feed chamber) and the membrane, and/or in a return pipe between the membrane and one or more feed chambers (e.g., the at least one feed chamber, the at least one other feed chamber).

The at least one desaturation unit can be selected from the group consisting of: a fluidized bed reactor, a softener, an ion exchanger, an absorber, and combinations thereof.

In at least one embodiment, the system includes, and/or is, an open loop system that is open, or substantially open, to atmosphere. Accordingly, the pressure of the concentrated feed stream in one or more return pipes (e.g., the at least one return pipe) can be reduced by passing the concentrated feed stream through the open loop system.

In at least another embodiment, the pressure exchanger is configured to reduce the pressure of the concentrated feed stream in one or more return pipes (e.g., the at least one return pipe) to substantially atmospheric pressure.

In at least another embodiment, the system further comprises at least one pre-treatment unit for pre-treating the feed water prior to delivery of the feed water to the membrane. A non-limiting example of a pre-treatment unit includes at least one filter unit.

As mentioned above herein, the membrane may be selected from the group consisting of: a reverse osmosis (RO) membrane, a nanofiltration (NF) membrane, a forward osmosis (FO) membrane, an ultrafiltration (UF) membrane, low rejection membranes and combinations thereof.

These and other objectives and features of the invention are apparent in the disclosure, which includes the above and ongoing written specification.

It is one object of the present invention to provide a method of cleaning feed water of variable quality, the method comprising:
delivering feed water to at least one at least one first membrane to create a first concentrated feed stream and an intermediate water stream;
passing the intermediate water stream to at least one second membrane to create a second concentrated feed stream and a product water stream;
wherein said at least one first membrane is an osmotically assisted reverse osmosis;

further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

It is another object of the present invention to provide the method as defined above, additionally comprising step of returning at least one selected from a group consisting of the first concentrated feed stream, the second concentrated feed stream and any combination thereof to at least one selected from a group consisting of said at least one first membrane, said at least one second membrane and any combination thereof.

It is another object of the present invention to provide the method as defined above, wherein at least one selected from a group consisting of the first concentrated feed stream, the second concentrated feed stream and any combination thereof is combined with additional feed water.

It is another object of the present invention to provide the method as defined above, additionally comprising step of passing at least one selected from a group consisting of the feed water, the first concentrated feed stream, the second concentrated feed stream, intermediate water stream and any combination thereof through at least one desaturation unit, adapted to at least partially precipitate particulates or remove minerals and to form a supernatant.

It is another object of the present invention to provide the method as defined above, further comprising circulating the supernatant from said desaturation unit to at least one selected from a group consisting of said at least one first membrane, said at least one second membrane and any combination thereof.

It is another object of the present invention to provide the method as defined above, wherein the pressure of the first or second concentrated feed stream is reduced to substantially atmospheric pressure via at least one pressure exchanger.

It is another object of the present invention to provide the method as defined above, further comprising step of pre-treating the feed water.

It is another object of the present invention to provide the method as defined above, wherein the pre-treating the feed water further comprises: filtering the feed water.

It is another object of the present invention to provide the method as defined above, further comprising: pumping the filtered feed water at high pressure through at least one selected from a group consisting of said at least one first membrane, said at least one second membrane and any combination thereof.

It is another object of the present invention to provide the method as defined above, additionally comprising step of reducing the pressure of the first or second concentrated feed stream via a pressure exchanger;
wherein the reducing the pressure of the first or second concentrated feed stream is performed prior to the returning the concentrated feed stream to said at least one first membrane, said at least one second membrane and any combination thereof.

It is another object of the present invention to provide a system for cleaning feed water of variable quality, the system comprising:
an inlet for selectively delivering feed water to at least one first membrane to create a first concentrated feed stream and an intermediate product water stream;
at least one delivery pipe for delivering the intermediate water stream to at least one second membrane to create a second concentrated feed stream and a product water stream;
at least one product water outlet for removal of the product water stream;
wherein said at least one first membrane is an osmotically assisted reverse osmosis;
further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

It is another object of the present invention to provide the system as defined above, additionally comprising return pipe for returning at least one selected from a group consisting of the first concentrated feed stream, the second concentrated feed stream and any combination thereof to at least one selected from a group consisting of said at least one first membrane, said at least one second membrane and any combination thereof.

It is another object of the present invention to provide the system as defined above, wherein at least one selected from a group consisting of the first concentrated feed stream, the second concentrated feed stream and any combination thereof is combined with additional feed water.

It is another object of the present invention to provide the system as defined above, additionally comprising delivery pipe for passing at least one selected from a group consisting of the feed water, the first concentrated feed stream, the second concentrated feed stream, intermediate water stream and any combination thereof through at least one desaturation unit, adapted to at least partially precipitate particulates or remove minerals and to form a supernatant.

It is another object of the present invention to provide the system as defined above, further comprising at least one return pipe for circulating the supernatant from said desaturation unit to at least one selected from a group consisting of said at least one first membrane, said at least one second membrane and any combination thereof.

It is another object of the present invention to provide the system as defined above, wherein the at least one desaturation unit is selected from the group consisting of: a fluidized bed reactor, a softener, an ion exchanger, an absorber, and combinations thereof.

It is another object of the present invention to provide the system as defined above, further comprising an open loop system open to atmosphere, wherein the pressure of the first or second concentrated feed stream is reduced by passing the first or second concentrated feed stream through the open loop system.

It is another object of the present invention to provide the system as defined above, additionally comprising at least one pressure exchanger that is configured to reduce pressure of the first or second concentrated feed stream prior to feeding the first or second concentrated feed stream through the at least one desaturation unit; wherein the pressure exchanger is configured to reduce the pressure of the first or second concentrated feed stream to substantially atmospheric pressure.

It is another object of the present invention to provide the system as defined above, further comprising a pre-treatment unit for pre-treating the feed water.

It is another object of the present invention to provide the system as defined above, wherein the pre-treatment unit comprises a filter unit.

It is one object of the present invention to provide a method of cleaning feed water of variable quality, the method comprising:
delivering feed water to at least one at least one first membrane to create a first concentrated feed stream and an intermediate water stream;
passing the intermediate water stream to at least one second membrane to create a second concentrated feed stream and a product water stream;
wherein said at least one first membrane is an osmotically assisted reverse osmosis; further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

It is another object of the present invention to provide the method as defined above, additionally comprising step of returning at least one selected from a group consisting of the first concentrated feed stream, the second concentrated feed stream, intermediate water stream and any combination thereof to at least one selected from a group consisting of said at least one first membrane, said at least one second membrane and any combination thereof.

It is another object of the present invention to provide the method as defined above, wherein at least one selected from a group consisting of the first concentrated feed stream, the second concentrated feed stream, intermediate water stream and any combination thereof is combined with additional feed water.

It is another object of the present invention to provide the method as defined above, additionally comprising step of passing at least one selected from a group consisting of the feed water, the first concentrated feed stream, the second concentrated feed stream, intermediate water stream and any combination thereof through at least one desaturation unit, adapted to at least partially precipitate particulates or remove minerals and to form a supernatant.

It is another object of the present invention to provide the method as defined above, further comprising circulating the supernatant from said desaturation unit to at least one selected from a group consisting of said at least one first membrane, said at least one second membrane and any combination thereof.

It is another object of the present invention to provide the method as defined above, wherein the pressure of at least one selected from a group consisting of first concentrated feed stream, second concentrated feed stream, said intermediate water stream and any combination thereof is reduced to substantially atmospheric pressure via at least one pressure exchanger.

It is another object of the present invention to provide the method as defined above, further comprising step of pre-treating the feed water.

It is another object of the present invention to provide the method as defined above, wherein the pre-treating the feed water further comprises: filtering the feed water.

It is another object of the present invention to provide the method as defined above, further comprising: pumping the filtered feed water at high pressure through at least one selected from a group consisting of said at least one first membrane, said at least one second membrane and any combination thereof.

It is another object of the present invention to provide the method as defined above, additionally comprising step of reducing the pressure of at least one selected from a group consisting of second concentrated feed stream, first concentrated feed stream, said intermediate water stream and any combination thereof via a pressure exchanger; wherein the reducing the pressure of at least one selected from a group consisting of second concentrated feed stream, first concentrated feed stream, said intermediate water stream and any combination thereof is performed prior to the returning the same to said at least one first membrane, said at least one second membrane and any combination thereof.

It is another object of the present invention to provide a system for cleaning feed water of variable quality, the system comprising:
an inlet for selectively delivering feed water to at least one first membrane to create a first concentrated feed stream and an intermediate product water stream;
at least one delivery pipe for delivering the intermediate water stream to at least one second membrane to create a second concentrated feed stream and a product water stream;
at least one product water outlet for removal of the product water stream;
wherein said at least one first membrane is an osmotically assisted reverse osmosis;
further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

It is another object of the present invention to provide the system as defined above, additionally comprising return pipe for returning at least one selected from a group consisting of the first concentrated feed stream, the second concentrated feed stream, intermediate water stream and any combination thereof to at least one selected from a group consisting of said at least one first membrane, said at least one second membrane and any combination thereof.

It is another object of the present invention to provide the system as defined above, wherein at least one selected from a group consisting of the first concentrated feed stream, the second concentrated feed stream, intermediate water stream and any combination thereof is combined with additional feed water.

It is another object of the present invention to provide the system as defined above, additionally comprising delivery pipe for passing at least one selected from a group consisting of the feed water, the first concentrated feed stream, the second concentrated feed stream, intermediate water stream and any combination thereof through at least one desaturation unit, adapted to at least partially precipitate particulates or remove minerals and to form a supernatant.

It is another object of the present invention to provide the system as defined above, further comprising at least one return pipe for circulating the supernatant from said desaturation unit to at least one selected from a group consisting of said at least one first membrane, said at least one second membrane and any combination thereof.

It is another object of the present invention to provide the system as defined above, wherein the at least one desaturation unit is selected from the group consisting of: a fluidized bed reactor, a softener, an ion exchanger, an absorber, and combinations thereof.

It is another object of the present invention to provide the system as defined above, further comprising an open loop system open to atmosphere, wherein the pressure of at least one selected from a group consisting of the first concentrated feed stream, the second concentrated feed stream, intermediate water stream and any combination thereof is reduced by passing at least one selected from a group consisting of the first concentrated feed stream, the second concentrated feed stream, intermediate water stream and any combination thereof through the open loop system.

It is another object of the present invention to provide the system as defined above, additionally comprising at least one pressure exchanger that is configured to reduce pressure of at least one selected from a group consisting of the first concentrated feed stream, the second concentrated feed stream, intermediate water stream and any combination thereof prior to feeding the at least one selected from a group consisting of the first concentrated feed stream, the second concentrated feed stream, intermediate water stream and any combination thereof through the at least one desaturation unit; wherein the pressure exchanger is configured to reduce the pressure of at least one selected from a group consisting of the first concentrated feed stream, the second concentrated feed stream, intermediate water stream and any combination thereof to substantially atmospheric pressure.

It is another object of the present invention to provide the system as defined above, further comprising a pre-treatment unit for pre-treating the feed water.

It is another object of the present invention to provide the system as defined above, wherein the pre-treatment unit comprises a filter unit.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

What is claimed is:

1. A method of cleaning feed water of variable quality, the method comprising:
delivering feed water to at least one first membrane to create a first concentrated feed stream and an intermediate water stream;
passing the intermediate water stream to at least one second membrane to create a second concentrated feed stream and a product water stream;
wherein the at least one first membrane is an osmotically assisted reverse osmosis;
further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

2. The method of claim 1, additionally comprising step of returning at least one selected from the group consisting of the first concentrated feed stream, the second concentrated feed stream, intermediate water stream and any combination thereof to at least one selected from the group consisting of the at least one first membrane, the at least one second membrane and any combination thereof.

3. The method of claim 1, wherein at least one selected from the group consisting of the first concentrated feed stream, the second concentrated feed stream, intermediate water stream and any combination thereof is combined with additional feed water.

4. The method of claim 1, additionally comprising step of passing at least one selected from the group consisting of the feed water, the first concentrated feed stream, the second concentrated feed stream, intermediate water stream and any combination thereof through at least one desaturation unit, adapted to at least partially precipitate particulates or remove minerals and to form a supernatant.

5. The method of claim 4, further comprising circulating the supernatant from the desaturation unit to at least one selected from the group consisting of the at least one first membrane, the at least one second membrane and any combination thereof.

6. The method of claim 1, wherein the pressure of at least one selected from the group consisting of first concentrated feed stream, second concentrated feed stream, the intermediate water stream and any combination thereof is reduced to substantially atmospheric pressure via at least one pressure exchanger.

7. The method of claim 1, further comprising step of pre-treating the feed water.

8. The method of claim 7, wherein the pre-treating the feed water further comprises:
filtering the feed water.

9. The method of claim 8, further comprising:
pumping the filtered feed water at high pressure through at least one selected from the group consisting of the at least one first membrane, the at least one second membrane and any combination thereof.

10. The method of claim 1, additionally comprising step of reducing the pressure of at least one selected from the group consisting of second concentrated feed stream, first concentrated feed stream, the intermediate water stream and any combination thereof via a pressure exchanger;
wherein the reducing the pressure of at least one selected from the group consisting of second concentrated feed stream, first concentrated feed stream, the intermediate water stream and any combination thereof is performed prior to the returning the same to the at least one first membrane, the at least one second membrane and any combination thereof.

11. A system for cleaning feed water of variable quality, the system comprising:
an inlet for selectively delivering feed water to at least one first membrane to create a first concentrated feed stream and an intermediate product water stream;
at least one delivery pipe for delivering the intermediate water stream to at least one second membrane to create a second concentrated feed stream and a product water stream;
at least one product water outlet for removal of the product water stream;
wherein the at least one first membrane is an osmotically assisted reverse osmosis;
further wherein the at least one second membrane is selected from the group consisting of: a reverse osmosis (RO) membrane, a nanofiltration (NF) membrane, a forward osmosis (FO) membrane, an ultrafiltration (UF) membrane, low rejection membranes, OARO stage and combinations thereof.

12. The system of claim 11, additionally comprising return pipe for returning at least one selected from the group consisting of the first concentrated feed stream, the second concentrated feed stream, intermediate water stream and any combination thereof to at least one selected from the group consisting of the at least one first membrane, the at least one second membrane and any combination thereof.

13. The system of claim 11, wherein at least one selected from the group consisting of the first concentrated feed stream, the second concentrated feed stream, intermediate water stream and any combination thereof is combined with additional feed water.

14. The system of claim 11, additionally comprising delivery pipe for passing at least one selected from the group consisting of the feed water, the first concentrated feed stream, the second concentrated feed stream, intermediate water stream and any combination thereof through at least one desaturation unit, adapted to at least partially precipitate particulates or remove minerals and to form a supernatant.

15. The system of claim 14, further comprising at least one return pipe for circulating the supernatant from the desaturation unit to at least one selected from the group consisting of the at least one first membrane, the at least one second membrane and any combination thereof.

16. The system of claim 14, wherein the at least one desaturation unit is selected from the group consisting of: a fluidized bed reactor, a softener, an ion exchanger, an absorber, and combinations thereof.

17. The system of claim 14, further comprising an open loop system open to atmosphere, wherein the pressure of at least one selected from the group consisting of the first concentrated feed stream, the second concentrated feed stream, intermediate water stream and any combination thereof is reduced by passing at least one selected from the group consisting of the first concentrated feed stream, the second concentrated feed stream, intermediate water stream and any combination thereof through the open loop system.

18. The system of claim 14, additionally comprising at least one pressure exchanger that is configured to reduce pressure of at least one selected from the group consisting of the first concentrated feed stream, the second concentrated feed stream, intermediate water stream and any combination thereof prior to feeding the at least one selected from the group consisting of the first concentrated feed stream, the second concentrated feed stream, intermediate water stream and any combination thereof through the at least one desaturation unit; wherein the pressure exchanger is configured to reduce the pressure of at least one selected from the group consisting of the first concentrated feed stream, the second concentrated feed stream, intermediate water stream and any combination thereof to substantially atmospheric pressure.

19. The system of claim 14, further comprising a pre-treatment unit for pre-treating the feed water.

20. The system of claim 19, wherein the pre-treatment unit comprises a filter unit.
